(19) United States
(12) Patent Application Publication
(10) Pub. No.: US 2008/0242373 A1
(43) Pub. Date: Oct. 2, 2008

(54) METHOD AND DEVICE FOR PROVIDING POSITION INFORMATION

(75) Inventors: WEI LU, TOKYO (JP); MICHIHIRO MURA, KANAGAWA (JP)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/691,141

(22) Filed: Mar. 26, 2007

(51) Int. Cl. H04M 1/00

(52) U.S. Cl. 455/575.1

(57) ABSTRACT

A method and wireless device for providing position information as provided enables increased control by the wireless device of location services. The method includes processing a location services request at the wireless device. In response to the location services request, a preferred schedule for location update messages is then determined at the wireless device, where the preferred schedule is based on at least one operating parameter of the wireless device. Location update messages are then transmitted from the wireless device according to the preferred schedule.

### FIELD OF THE INVENTION

The present invention relates generally to wireless communication devices, and in particular to scheduling transmissions of location update messages from a wireless communication device.

### BACKGROUND

Mobile telephones increasingly include a locating feature that enables the geographic location of the mobile telephones to be either displayed on the phones or transmitted to a remote receiver. These features are generally called location services (abbreviated as LCS, for “LoCation Services”). LCS features that display location coordinates on a telephone are useful, for example, to phone users who need to know where they are located relative to geographic map coordinates. Thus LCS features can enable a mobile telephone user to initiate a location request where the telephone acts as a Global Positioning System (GPS) terminal. Also, location requests may be initiated by third parties and transmitted to a telephone over a wireless network. Such third party requests are useful in various circumstances. For example, mobile telephone networks may be able to improve network efficiency and provide better Quality of Service (QoS) and roaming rates to a mobile user if the network can periodically monitor a mobile telephone location. Also, emergency services can sometimes save lives by rapidly and accurately identifying where emergency phone calls have originated. Other useful location-based services and data that can be provided through a mobile telephone include maps, weather forecasts, traffic data, and local news. Further, some parents may seek to supervise for example their teenage children using the ability to learn their children's precise location through a mobile telephone locator.

Various locating technologies can be used to determine the location of a wireless communication device such as a mobile telephone. For example, the Global Positioning System (GPS) can be used to identify a location anywhere in the world of some mobile telephones. However, because most mobile telephones are already operatively connected to land-based network stations, and do not need to communicate solely with satellites, Assisted GPS (A-GPS) services are commonly used to incorporate better and more efficient location services into mobile telephones. Secure User Plane Location (SUPL) is a standard developed by the Open Mobile Alliance (OMA) that concerns the transfer of assistance data and positioning data between a wireless electronic device and a location platform. A “user plane” means that assistance data and positioning data are transmitted between the device and the location platform over a conventional wireless communication channel such as a General Packet Radio Service (GPRS) channel. User plane communications are thus distinguished from control plane communications where assistance data and positioning data are transmitted between a device and a location platform over a separate signaling channel in a network. Before a wireless communication device can utilize the location services of a location platform, the device and the location platform generally are mutually authenticated. Such mutual authentication can include obtaining authentication data, such as shared keys, from a particular domain. For example, a particular domain associated with a location platform can be identified using a Fully Qualified Domain Name (FQDN), such as an internet protocol (IP) version 4 address, that is included in a universal integrated circuit card (UICC) that is operatively coupled to the wireless device. The device can use the FQDN to contact the location platform and complete mutual authentication.

The above described locating technologies and LCS applications can consume a significant amount of power and processing resources of a wireless communication device such as a mobile telephone. In addition to ancillary processes such as mutual authentication, location services generally require periodic transmissions of location update messages. Acquiring location information such as geographic coordinates, and then transmitting the location information in a location update message consumes device battery power and employs processor resources that may cause other processor applications of a device to be slowed down. Further, frequent transmission of such messages contributes to network congestion and can reduce network bandwidth for all network users.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating a wireless communication device in the form of a mobile telephone, according to some embodiments of the present invention.

FIG. 2 is a message sequence chart illustrating periodic positioning sessions between a wireless network server and a client device, such as a mobile telephone, according to the prior art.

FIG. 3 is a message sequence chart illustrating periodic positioning sessions between a wireless network server and a client device, such as a mobile telephone, according to some embodiments of the present invention.

FIG. 4 is a general flow diagram illustrating a method for providing position information of a wireless device, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to providing position information of a wireless device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

According to one aspect, the present invention is a method for providing position information of a wireless device. The method includes processing a location services request at the wireless device. In response to the location services request, a preferred schedule for location update messages is then determined at the wireless device, where the preferred schedule is based on at least one operating parameter of the wireless device. Location update messages are then transmitted from the wireless device according to the preferred schedule. Operating parameters of the wireless device can include, for example, battery power parameters, network traffic congestion parameters, or processor use parameters. By enabling increased control by a wireless device of location services, rather than providing such control at a network server, overall operating efficiency of the wireless device and Quality of Service (QoS) of device applications can be improved.

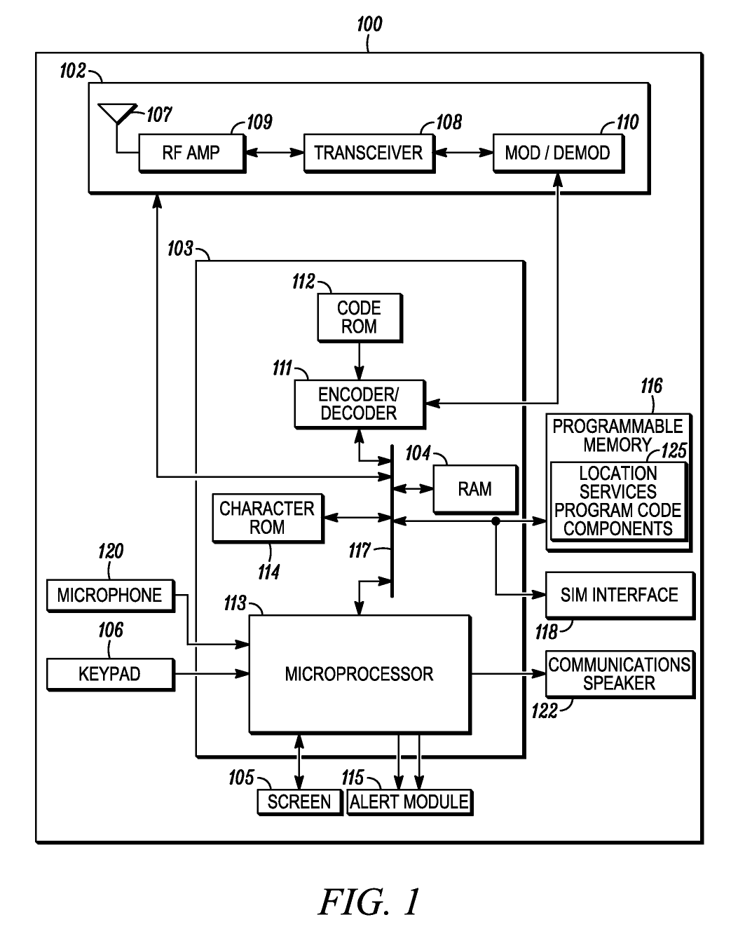

Referring to FIG. 1, a schematic diagram illustrates a wireless communication device in the form of a mobile telephone 100, according to some embodiments of the present invention. The telephone 100 comprises a radio frequency communications unit 102 coupled to be in communication with a common data and address bus 117 of a processor 103. The telephone 100 also has a keypad 106, and a display screen 105, such as a touch screen coupled to be in communication with the processor 103.

The processor 103 also includes an encoder/decoder 111 with an associated code Read Only Memory (ROM) 112 for storing data for encoding and decoding voice or other signals that may be transmitted or received by the mobile telephone 100. The processor 103 further includes a microprocessor 113 coupled, by the common data and address bus 117, to the encoder/decoder 111, a character Read Only Memory (ROM) 114, a Random Access Memory (RAM) 104, programmable memory 116 and a Subscriber Identity Module (SIM) interface 118. The programmable memory 116 and a SIM operatively coupled to the SIM interface 118 each can store, among other things, selected text messages and a telephone number database comprising a number field for telephone numbers and a name field for identifiers associated with one of the numbers in the name field.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that is coupled to the encoder/decoder 111.

The microprocessor 113 has ports for coupling to the keypad 106 and to the display screen 105. The microprocessor 113 further has ports for coupling to an alert module 115 that typically contains an alert speaker, vibrator motor and associated drivers, to a microphone 120 and to a communications speaker 122. The character ROM 114 stores code for decoding or encoding data such as text messages that may be received by the communications unit 102. In some embodiments of the present invention, the character ROM 114, the programmable memory 116, or a SIM also can store operating code (OC) for the microprocessor 113 and code for performing functions associated with the mobile telephone 100. For example, the programmable memory 116 can comprise location services computer readable program code components 125 configured to cause execution of a method for providing position information, according to an embodiment of the present invention.

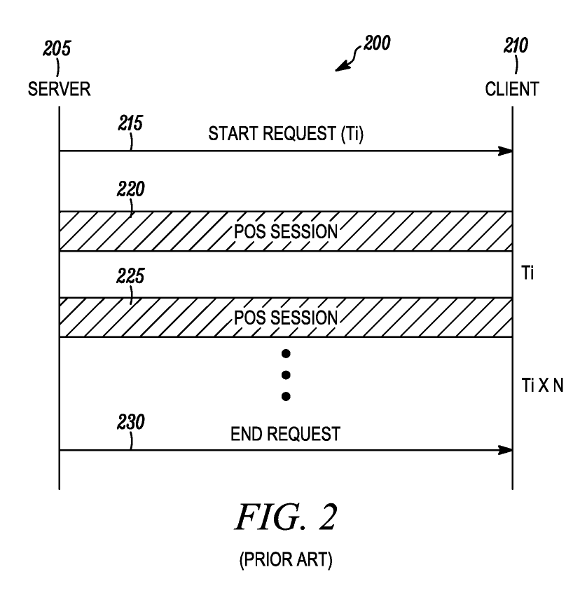

Referring to FIG. 2, a message sequence chart 200 illustrates periodic positioning sessions between a wireless network server 205 and a client device 210, such as a mobile telephone, according to the prior art. A location services request message 215 is first sent from the network server 205 to the client device 210. The location services request message 215 can be transmitted in response to a request for location services (LCS) from various sources. For example, such requests can include mobile terminated location requests (MTLRs), network initiated location requests (NILRs), or mobile originated location requests (MOLRs). MTLRs are location requests that are initiated by another network user, such as other mobile stations, websites or information services. NILRs are location requests that are received from a mobile network where the network is not requesting verification or notification. Typically, NILRs are used for locating mobile stations for emergency or law-enforcement purposes. MOLRs are location requests that originate from within the client device 210 itself.

The location services request message 215 may include a requested fixed time period (Ti) between location update messages. For example, if the location services request message 215 is transmitted in response to an MTLR concerning a real time movement tracking application for use by the client device 210, then the location services request message 215 may include a requested fixed time period (Ti) between location update messages that is very short. Effective real time tracking of the movement of the client device 210 in a vehicle, for example, may require a fixed time period (Ti) of only a few seconds between location update messages. Alternatively, if the location services request message 215 is transmitted in response to an MOLR concerning a request for local weather information, then a fixed time period (Ti) of many minutes or even hours may be adequate.

In response to the location services request message 215, the client device 210 initiates a first positioning session 220, such as a secure user plane location (SUPL) session, that includes a location update message being transmitted from the client device 210 to the network server 205. The client device 210 then waits for the fixed time period (Ti) that was specified in the location services request message 215 before initiating a subsequent positioning session 225. Periodic additional positioning sessions are then initiated by the client device 210, where a delay equal to the fixed time period (Ti) is included between each positioning session, until the network server 205 transmits a positioning end request message 230 to the client device 210.

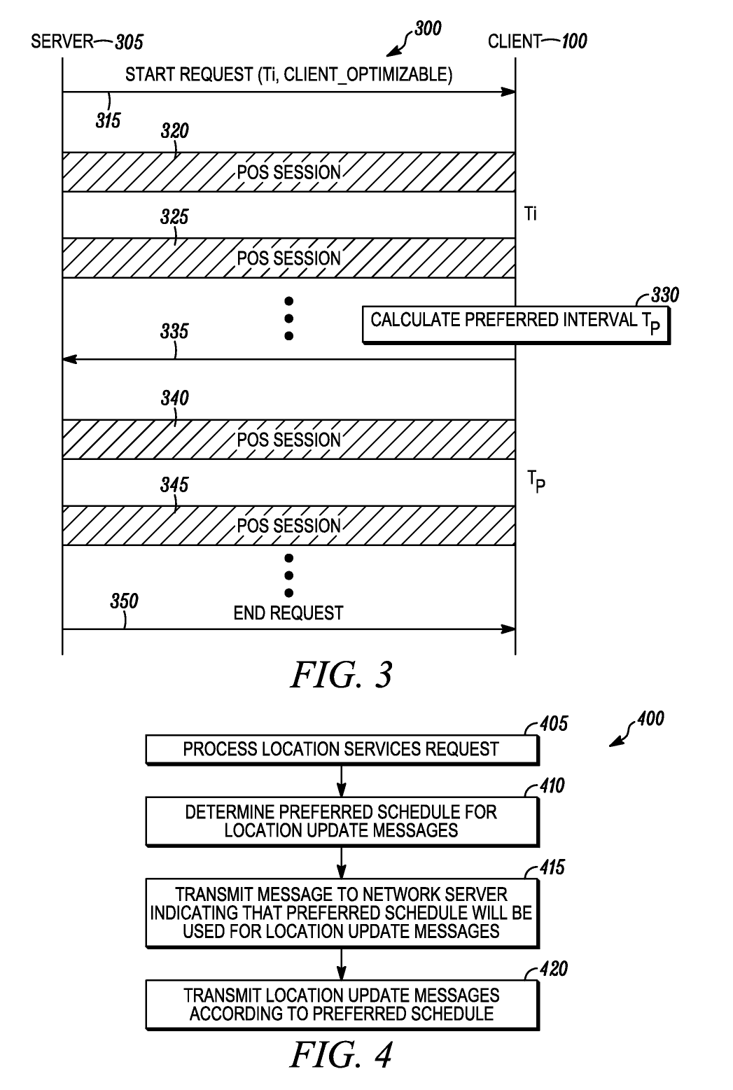

Referring to FIG. 3, a message sequence chart 300 illustrates periodic positioning sessions between a wireless network server 305 and a client device such as the mobile telephone 100, according to some embodiments of the present invention. A location services request message 315 is first sent from the network server 305 to the mobile telephone 100. The location services request message 315 can be transmitted in response to a request for location services (LCS) from various sources and can include, for example, a mobile terminated location request (MTLR), network initiated location request (NILR), or mobile originated location request (MOLR).

The location services request message 315 may include a requested fixed time period (Ti) between location update messages. In addition, the location services request message 315 can include a client optimizable flag that indicates to the mobile telephone 100 that location update messages can be transmitted according to a preferred schedule determined by the mobile telephone 100. Such a client optimizable flag can be in the form of any variable, signal or other indication in the location services request message 315. The mobile telephone 100 is thus made aware that it can determine a preferred schedule for location update messages, which preferred schedule can optimize the provision of location services by considering various other operating parameters of the mobile telephone 100. For example, such operating parameters can include a battery power parameter, a network traffic congestion parameter, or a processor use parameter.

In response to the location services request message 315, the mobile telephone 100 initiates a first positioning session 320, such as a secure user plane location (SUPL) session, that includes a location update message being transmitted from the mobile telephone 100 to the network server 305. Initially, the mobile telephone 100 then may wait for the fixed time period (Ti) that was specified in the location services request message 315 before initiating a subsequent positioning session 325.

However, the fixed time period (Ti) that was specified in the location services request message 315 may be inefficient for the mobile telephone 100, or inefficient for a network in which the mobile telephone 100 is operating. Thus a proposed schedule for location update messages may be different from a preferred schedule for location update messages. For example, a battery power level of the mobile telephone 100 may be low, and positioning sessions separated by only a short fixed time period (Ti) may quickly drain remaining power levels; or the microprocessor 113 may be processing a large number of processor intensive applications, such that additional processing required from positioning sessions may slow down other applications running on the mobile telephone 100; or a network in which the mobile telephone 100 is operating may be very congested, and transmission of control and other messages related to location services may add to such congestion and reduce network performance.

Therefore, at block 330, the mobile telephone 100 determines a preferred schedule for location update messages by calculating a preferred time period (Tp) between location update messages. The mobile telephone 100 then transmits a message 335 to the network server 305 indicating that the preferred schedule for location update messages will be used in response to the location services request message 315. Subsequent positioning sessions 340, 345 that include transmitting location update messages from the mobile telephone 100 to the network server 305 are then separated by the preferred time period (Tp), rather than by the initially specified fixed time period (Ti). The preferred time period (Tp) may be significantly longer than the initially specified fixed time period (Ti), thus enabling the mobile telephone 100 to conserve power, processing, and/or network bandwidth resources. The preferred schedule can be followed until the network server 305 transmits a positioning end request message 350 to the mobile telephone 100.

According to some embodiments of the present invention, a preferred schedule for location update messages may comprise a simple preferred time period (Tp) between location update messages, or may comprise a complex, variable schedule for location update messages. For example, the mobile telephone 100 may schedule location update messages based on a resource use estimation algorithm stored in the programmable memory 116. Such a resource use estimation algorithm can be readily programmed by one having ordinary skill in the art, and can consider factors such as prior resource use histories of the mobile telephone 100 or prior use histories of a network in which the mobile telephone 100 operates. Thus a preferred schedule for location update messages can be determined that minimizes location update messages during periods of estimated low battery power, estimated high usage of the microprocessor 113, or estimated high network congestion. Conversely, such a preferred schedule can transmit location update messages according to a proposed schedule received from the network server 305 during periods of estimated adequate battery power, estimated low usage of the microprocessor 113, or estimated low network congestion.

Further, according to still other embodiments of the present invention, a preferred schedule for location update messages can be determined in real time based on actual current operating parameters of the mobile telephone 100. Thus, for example, the mobile telephone 100 can immediately increase the length of a preferred time period (Tp) between location update messages whenever necessary. If, for example, during use of location services on the mobile telephone 100 another processor intensive application such as a speech synthesis application suddenly requires significant resources of the microprocessor 113, the location services program code components 125 can cause an immediate increase in the length of a preferred time period (Tp) between location update messages so as to provide more processor resources for the speech synthesis application. Further, the location services program code components 125 can cause relative comparisons of quality of service (QoS) requirements between requested location services and other application services provided by the mobile telephone 100. In light of the present disclosure, writing the location services program code components 125 including the above described features are within the capability of one of ordinary skill in the art, without requiring undue experimentation.

Positioning sessions that result in transmission of location update messages, which include the geographic location of the mobile telephone 100, can obtain such geographic location using various technologies including a global positioning system, assisted global positioning system, observed time difference, enhanced forward link triangulation, time of arrival, time difference of arrival, angle of arrival, multipath fingerprinting, timing advance, enhanced observed time difference, or hybrid geolocation technology, all of which are well known in the art.

Although various embodiments of the present invention have been described in relation to the mobile telephone 100, those skilled in the art will appreciate that embodiments of the present invention can be included on various other types of wireless devices, such as notebook computers, personal digital assistants (PDAs), handheld radios, vehicle location systems, and various other electronic appliances that may employ location services (LCS).

Referring to FIG. 4, a general flow diagram illustrates a method 400 for providing position information of a wireless device, according to some embodiments of the present invention. At step 405, a location services request is processed at the wireless device. For example, the location services request message 315 is processed at the mobile telephone 100.

At step 410, in response to the location services request, a preferred schedule for location update messages is determined, wherein the preferred schedule is based on at least one operating parameter of the wireless device. For example, at block 330, a preferred schedule is determined including calculating a preferred time period (Tp) between location update messages.

At step 415, a message from the wireless device is transmitted to the network server indicating that the preferred schedule for location update messages will be used in response to the location services request. For example, the message 335 is transmitted to the network server 305 indicating that the preferred schedule for location update messages will be used in response to the location services request message 315. Further, according to an alternative embodiment of the present invention, such a message, which indicates that the preferred schedule for location update messages will be used in response to the location services request, can be transmitted during a positioning session.

At step 420, location update messages are transmitted from the wireless device according to the preferred schedule. For example, the subsequent positioning sessions 340, 345 that include transmission of a location update message are separated by the preferred time period (Tp).

Advantages of some embodiments of the present invention therefore include enabling a wireless device to determine a preferred schedule for location update messages based on at least one operating parameter of the wireless device. Because a wireless device itself is often best able to identify its own operating parameters such as battery power levels, processor demands, and network traffic congestion, enabling a wireless device to determine a preferred schedule for location update messages can significantly improve the overall operating efficiency of a wireless device.

It will be appreciated that embodiments of the invention described herein may be comprised of one or more conventional processors and unique stored program instructions that control the one or more processors to implement, in conjunction with certain non-processor circuits, some, most, or all of the functions of providing position information of a wireless device as described herein. The non-processor circuits may include, but are not limited to, a radio receiver, a radio transmitter, signal drivers, clock circuits, power source circuits, and user input devices. As such, these functions may be interpreted as steps of a method for providing position information of a wireless device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for providing position information of a wireless device, the method comprising:
processing a location services request at the wireless device;
determining at the wireless device, in response to the location services request, a preferred schedule for location update messages, wherein the preferred schedule is based on at least one operating parameter of the wireless device; and
transmitting location update messages from the wireless device according to the preferred schedule.

2. The method of claim 1, wherein the location services request comprises a proposed schedule for location update messages that is different from the preferred schedule for location update messages.

3. The method of claim 1, wherein the location services request is received from a network server.

4. The method of claim 3, further comprising transmitting a message from the wireless device to the network server indicating that the preferred schedule for location update messages will be used in response to the location services request.

5. The method of claim 1, wherein the preferred schedule for location update messages comprises a fixed time period between location update messages.

6. The method of claim 1, wherein the at least one operating parameter of the wireless device is a battery power parameter, a network traffic congestion parameter, or a processor use parameter.

7. The method of claim 1, wherein the location services request comprises a client optimizable flag that indicates to the wireless device that location update messages can be transmitted according to a preferred schedule determined by the wireless device.

8. The method of claim 1, wherein the location services request comprises a mobile terminated location request, a network initiated location request, or a mobile originated location request.

9. The method of claim 1, wherein the location update messages include the location of the wireless device obtained using a global positioning system, assisted global positioning system, observed time difference, enhanced forward link triangulation, time of arrival, time difference of arrival, angle of arrival, multipath fingerprinting, timing advance, enhanced observed time difference, or hybrid geolocation technology.

10. A wireless device for providing position information, the device comprising:
computer readable program code components configured to cause processing a location services request at the wireless device;
computer readable program code components configured to cause determining at the wireless device, in response to the location services request, a preferred schedule for location update messages, wherein the preferred schedule is based on at least one operating parameter of the wireless device; and
computer readable program code components configured to cause transmitting location update messages from the wireless device according to the preferred schedule.

11. The device of claim 10, wherein the location services request comprises a proposed schedule for location update messages that is different from the preferred schedule for location update messages.

12. The device of claim 10, wherein the location services request is received from a network server.

13. The device of claim 12, further comprising transmitting a message from the wireless device to the network server indicating that the preferred schedule for location update messages will be used in response to the location services request.

14. The device of claim 10, wherein the preferred schedule for location update messages comprises a fixed time period between location update messages.

15. The device of claim 10, wherein the at least one operating parameter of the wireless device is a battery power parameter, a network traffic congestion parameter, or a processor use parameter.

16. The device of claim 10, wherein the location services request comprises a client optimizable flag that indicates to the wireless device that location update messages can be transmitted according to a preferred schedule determined by the wireless device.

17. The device of claim 10, wherein the location services request comprises a mobile terminated location request, a network initiated location request, or a mobile originated location request.

18. The device of claim 10, wherein the location update messages include the location of the wireless device obtained using a global positioning system, assisted global positioning system, observed time difference, enhanced forward link triangulation, time of arrival, time difference of arrival, angle of arrival, multipath fingerprinting, timing advance, enhanced observed time difference, or hybrid geolocation technology.

19. A wireless device for providing position information, the device comprising:
means for processing a location services request at the wireless device;
means for determining at the wireless device, in response to the location services request, a preferred schedule for location update messages, wherein the preferred schedule is based on at least one operating parameter of the wireless device; and
means for transmitting location update messages from the wireless device according to the preferred schedule.
